(19) United States
(12) Patent Application Publication
(10) Pub. No.: US 2010/0043492 A1
(43) Pub. Date: Feb. 25, 2010

(54) JEWELRY AND METHOD OF MAKING THE SAME

(76) Inventor: L'Wren Scott, New York, NY (US)

Correspondence Address: SENNIGER POWERS LLP, 100 NORTH BROADWAY, 17TH FLOOR, ST LOUIS, MO, 63102, US

(21) Appl. No.: 12/390,940

(22) Filed: Feb. 23, 2009

Related U.S. Application Data
(60) Provisional application No. 61/030,844, filed on Feb. 22, 2008.

(51) Int. Cl. A44C 17/02; B29C 35/08; B23P 5/00

(52) U.S. Cl. 63/26; 264/400; 29/10

(57) ABSTRACT

Jewelry includes a stone having a groove extending at least partially around a periphery of the stone. A setting includes a wire received in and running along the groove to mount the stone in the setting. In one process, a groove is cut in the stone using a laser.

### CROSS-REFERENCE TO RELATED APPLICATION

The present application claims priority to U.S. Provisional Application No. 61/030,844, filed Feb. 22, 2008, the entirety of which is herein incorporated by reference.

### FIELD OF THE INVENTION

The present invention generally relates to a method of setting stones for use in jewelry and to jewelry made therefrom.

### BACKGROUND OF THE INVENTION

Conventionally, where jewelry is to include stones, particularly precious stones, these are cut to the desired shape and then polished. They must then be mounted into the metal support. Various means of mounting or setting the support are known. In one arrangement, the setting may include claws or bezels which grip the stone. Whilst these can securely hold the stone, they can detract from the aesthetic effect. In addition, if they become damaged, the stone may become loose and may even be lost.

An alternative arrangement for holding stones in position which is particularly used in necklaces, earrings and the like is to drill a hole through the stone. A fastening is then passed through the stone. The fastening may be, for example, the chain of the necklace itself or a separate fastening which is then connected to the necklace. Whilst this forms a secure connection to the stone, the stone itself may have lost value when the hole is formed.

A further drawback of these conventional forms of setting stones into jewelry is that the final piece can appear heavy due to the metal needed to hold the jewelry in position. Further, it usually means that an item is only attractive from one side and the user must take care in its positioning. This also restricts the designer in the ability to prepare a piece which allows as much of the stone to be seen as possible and for its natural beauty not to be covered by the metal setting.

### SUMMARY OF THE INVENTION

In one aspect, a process for preparing a stone for mounting in a setting of a jewelry piece generally comprises cutting a groove in the stone using a laser. The groove extends at least partially around a periphery of the stone. The groove is sized and shaped to receive the setting for mounting the stone in the setting.

In another aspect, jewelry generally comprises a stone having a groove extending at least partially around a periphery of the stone. A setting includes a wire received in and running along the groove to mount the stone in the setting.

### BRIEF DESCRIPTION OF THE DRAWINGS

FIG. 1 is a front perspective of a necklace on a woman's body, the necklace including a plurality of stones mounted in individual settings;

FIG. 2 is an enlarged side perspective of FIG. 1;

FIG. 3 is an enlarged perspective of one of the settings removed from the necklace;

FIG. 4 is a perspective of the stone of FIG. 3 exploded from the setting; and

FIG. 5 is an enlarged, fragmentary perspective of a portion of the necklace in FIG. 1.

Corresponding reference characters indicate corresponding parts throughout the drawings.

### DETAILED DESCRIPTION OF THE DRAWINGS

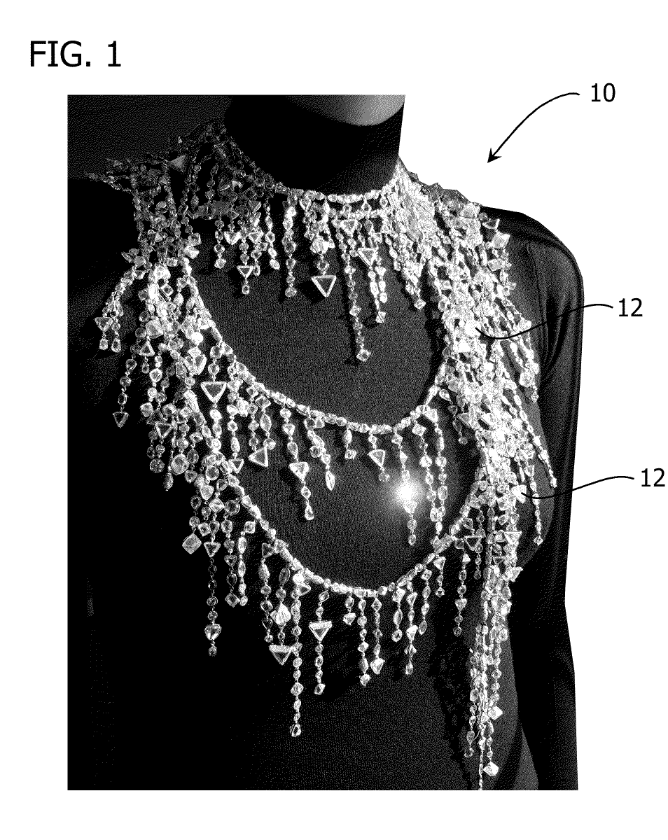

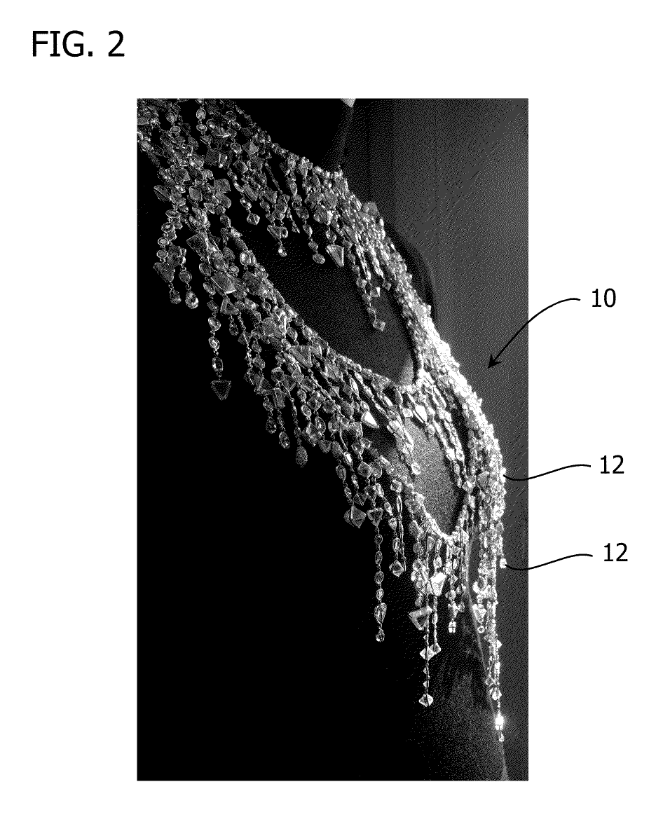

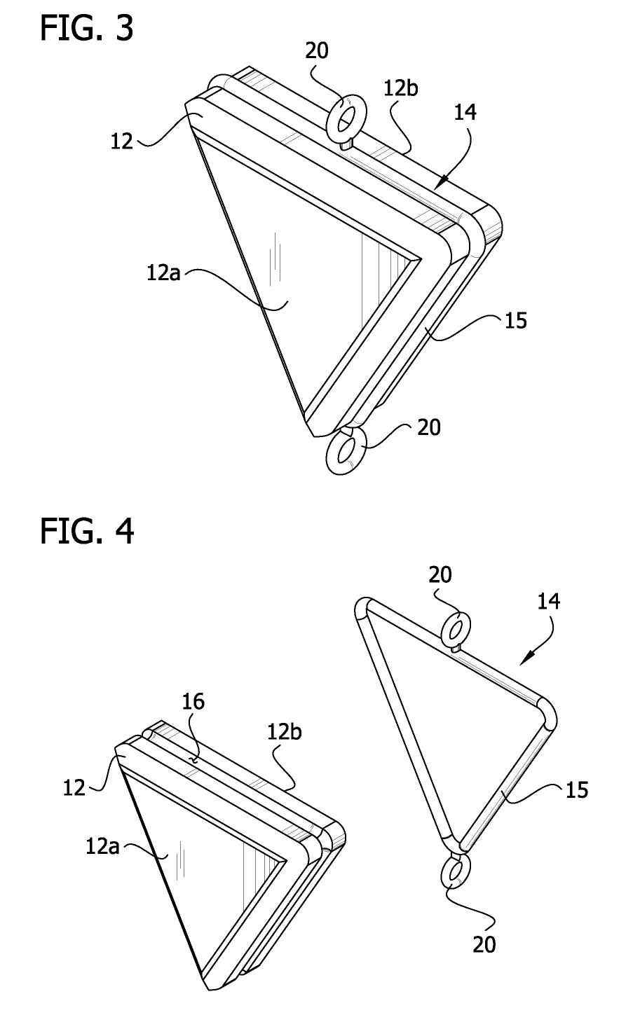

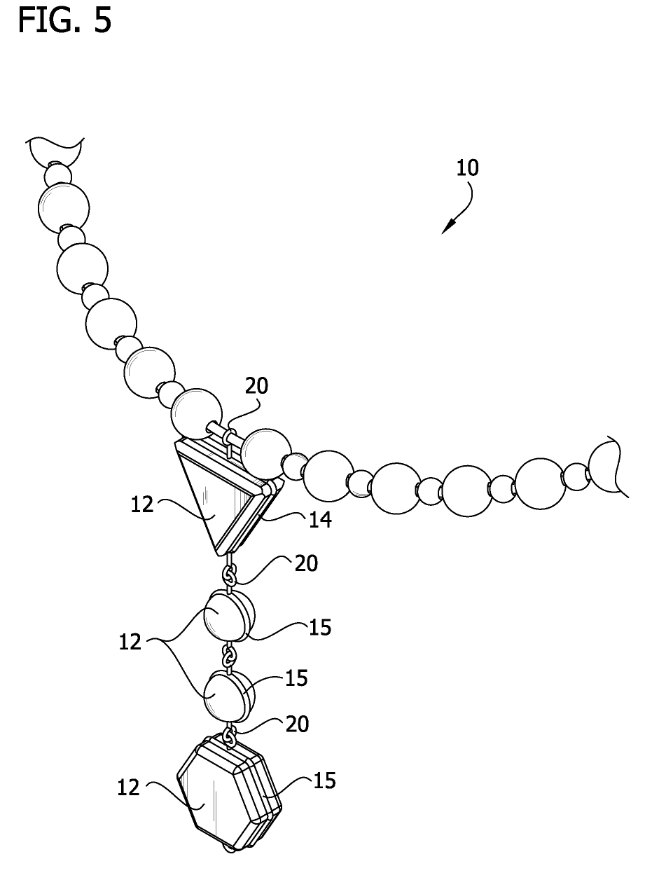

Referring to FIGS. 1 and 2, a necklace (broadly, a jewelry piece) is generally indicated at 10. The necklace includes stones 12 mounted on individual settings, generally indicated at 14, of the necklace. Referring to FIGS. 3 and 4, each setting 14 includes a wire 15 that is received in a groove 16 of the corresponding stone 12 to mount the stone in the setting. This configuration gives the necklace 10 the appearance that the stones 12 have movement and freedom, which is particularly desirable from an aesthetic standpoint. Each groove 16 extends at least partially around a periphery of the corresponding stone 12. In the illustrated embodiment, a length of the groove 16 extends around substantially an entirety of a peripheral edge margin of the stone 12, and the wire 15 extends along the entire length of the groove. Also, the groove 16 in the stone 12 in FIGS. 3 and 4 lies in a plane that is between opposite faces 12a, 12b of the stone.

Each groove 16 cut into the stone 12 may have a suitable width and depth. The width and depth of the groove 16 may be selected depending on the size of the stone 12. It will be appreciated that the size of the groove 16 required for mounting may depend on the size of the stone 12. For example, where a large stone 12 is to be mounted, a groove 16 with a relatively larger width and depth may be required to accept a thicker wire 15. However, for most stones 12, the grooves will generally be as small as possible. In general, the depth and width of the groove 16 may each measure from about 0.5 mm (0.02 in) to about 2 mm (0.08 in), and more specifically, the depth and width may each measure about 1 mm (0.04 in).

Each stone 12 may be of a desired shape and type, such as, but not limited to, a precious stone or semi-precious stone. For example, the stones 12 may be diamonds, emeralds, sapphires, rubies and the like. For purposes of the present disclosure, the term “stone” includes minerals, rocks such as lapis-lazuli, and organic materials such as amber. The stone 12 may be a natural stone, i.e. as it has come out of the ground, or one which has been cut. The stone 12 may be polished or unpolished.

In one method of making the necklace 10 or other piece of jewelry, such as a bracelet or earring, the groove 16 is cut using a laser cutter. Any suitable laser cutter may be used to form the groove 16 in the stone 12. Laser cutting the groove 16 offers various advantages. In particular, the small size of the groove 16 means that the value of the stone 12 is not compromised by the machining process. In addition, where the stone 12 is not cut, the stone is preserved so that the owner can choose to have it cut and conventionally mounted if they so choose at a later date.

After the groove 16 is cut using a laser cutter, the wire 15 is passed around the stone 12 in the groove to securely hold the stone. The wire 15 may be formed from a suitable material, including, but not limited to, precious metal, such as silver, gold and platinum. The dimensions of the wire 15 will be selected to fit within the groove 16. Ends of the wire 15 may be joined in any suitable manner and may be selected from those conventionally used in jewelry manufacture. In the illustrated embodiment, the setting 14 also includes at least one connector 20 secured to the wire 15 for connecting the setting 14 to a chain or other structure or for connecting the setting to another setting. In the illustrated embodiment, each connector 20 is a loop that interconnects with another loop connector so as to form a link. It is understood that the settings 14 may be secured to one another in other ways without departing from the scope of the present invention. The necklace 10 illustrated is 280 cm long and includes 7645 diamonds composed of a mix of rough natural and polished diamonds. Despite the weight of the stones 12, which is approximately 279.70 g, only 383.71 g of gold is required to form the settings 14 to hold the necklace 10 together.

It is understood that a piece of jewelry constructed according to the teachings of the present disclosure may be a necklace, earring, bracelet, ring, sautoir, scarf and the like. The jewelry may additionally include stones mounted by conventional techniques. The jewelry can be designed to take advantage of the freedom and movement provided by the setting.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A process for preparing a stone for mounting in a setting of a jewelry piece comprising:
cutting a groove in the stone using a laser, the groove extending at least partially around a periphery of the stone, the groove being sized and shaped to receive the setting for mounting the stone in the setting.

2. A process according to claim 1 wherein the groove extends around an entire peripheral edge of the stone.

3. A process according to claim 1 wherein the groove lies in a plane between opposite faces of the stone.

4. A process according to claim 1 wherein the groove measures from about 0.5 mm to about 2 mm in depth and width.

5. A process according to claim 1 further comprising mounting the stone in the setting, said mounting the stone in the setting comprising passing a wire around the stone in the groove to securely hold the stone.

6. A process according to claim 5 further comprising securing the setting to another setting that includes a stone.

7. A process according to claim 6 wherein said securing the setting to another setting includes interconnecting loops of the settings.

8. Jewelry comprising:
a stone having a groove extending at least partially around a periphery of the stone;
a setting including a wire received in and running along the groove to mount the stone in the setting.

9. Jewelry as set forth in claim 8 wherein the groove extends around an entire peripheral edge of the stone.

10. Jewelry as set forth in claim 9 wherein the groove measures from about 0.5 mm to about 2 mm in depth and width.

11. Jewelry as set forth in claim 8 wherein the stone comprises a plurality of stones and the setting comprises a plurality of settings, wherein each stone is mounted in one of the settings.

12. Jewelry as set forth in claim 11 wherein the settings include connectors connecting the settings to one another.

13. Jewelry as set forth in claim 12 wherein the connectors are loops secured to the wire.
